(19) United States
(12) Patent Application Publication
(10) Pub. No.: US 2014/0229539 A1
(43) Pub. Date: Aug. 14, 2014

(54) SYSTEM AND METHOD FOR TAG-BASED SOCIAL NETWORKING

(71) Applicant: Jason Daniel Powers, San Francisco, CA (US)

(72) Inventor: Jason Daniel Powers, San Francisco, CA (US)

(21) Appl. No.: 13/766,545

(22) Filed: Feb. 13, 2013

(51) Int. Cl. H04L 12/58

(52) U.S. Cl. CPC H04L 51/32
USPC 709/204

(57) ABSTRACT

A method for social interaction comprising tag-based user identification, location-based user identification, aggregated user information for search and categorization, and tag-based location ratings and reviews, and a mobile software application implementing such a method utilizing tag-based user interactive elements for optimal user experience and anonymity within a social networking context.

### BACKGROUND OF THE INVENTION

1. Field of the Invention

The invention relates to the field of social networking, and more particularly to the field of software applications for social connectivity and location-based review and ratings.

2. Discussion of the State of the Art

In the field of social networking applications, there exist multiple solutions for enabling individuals to connect and interact with each other, such as Facebook or LinkedIn or any of a variety of similar services for social connectivity. Such services have also become known for maintaining a repository of users' personal information such as name, age, and other personal identifiers, incurring concerns regarding the security and privacy of users. Furthermore, social networking services such as YELP™ allow users to rate and review establishments, but many users choose not to participate due to the inconvenience associated with writing a review.

What is needed, is a social interaction service that allows anonymous yet relevant interactions and sharing of socially-relevant data between users, protecting personal information while allowing individuals to connect with others based on their demographic information or preferences, which simplifies and streamlines the process of planning and coordinating social interactions, and which allows ratings and reviews to be submitted quickly and conveniently, promoting participation by users and establishment owners.

### SUMMARY OF THE INVENTION

Accordingly, the inventor has conceived and reduced to practice, in a preferred embodiment of the invention, a method for tag-based social connectivity and software application for the implementation of such a method.

According to a preferred embodiment of the invention, a method for social interaction based on tags rather than personally identifiable information, is disclosed. Such a method comprises a four-step process, each step optionally comprising further sub-steps as described in detail below (referring now to FIG. 4). The four steps of the method, each of which may be a component in a system implementing such a method, are a real-time anonymous social search (RASS) engine, real-time social curation engine (RSCE), social group coordination (SGC) engine, and real-time social grouping (RSG) engine. It will be appreciated that such steps as described below are exemplary and additional or alternate steps may be implemented according to the invention, however as envisioned by the inventor the steps described and illustrated herein are seen as an ideal configuration for implementing tag-based social interaction according to the invention.

A RASS engine may be implemented to accept input from users in the form of descriptive tags used as personal identifiers in place of detailed personally identifiable information which could include any number of things, from (for example) demographic descriptors (such as age, gender, sexual orientation, relationship status, etc.) to personality descriptors (hipster, partier, professional, relaxed, alternative) to identifiers of personal interests (sports enthusiast, music lover, beer snob, wine snob). Once a user has “tagged” themselves, the RASS may then begin recording the user's location at predetermined intervals (which might be customizable by a user to tailor performance) and based on the location and movement detected, passively assess whether or not that user is out in a publicly available social context. Upon said assessment, their location would then be aggregated with any other users in that area, but with all personally identifying information removed and only the user's generic characteristic “tags” remaining, facilitating anonymity and preventing security or privacy issues commonly associated with broadcasting user's personal information. This information, collected across an entire user base and stored in a cloud-hosted data store such as a database or other storage medium (rather than simply being stored on a user's device or broadcast between devices with no storage taking place), would then provide the necessary data to allow users to view concentrations of particular types of people with particular interests who were out in a social context (as illustrated in detail below, referring to FIG. 6). That user would then be able to use that information to make better, more informed decisions about where to spend their own social time, with the assumed goal of being around the particular type of person with whom that user has the most fun or most desires to interact and develop relationships, or optionally choosing to avoid certain types of individuals based on selectable exclusion tags to determine characteristics to be avoided. The system, based on a user's own tags, search history, and real time ratings (described below), will also be able to provide targeted recommendations about what activities or locations the user might enjoy, optionally incorporating tag-based exclusions as described previously.

An additional feature may be implemented by an RASS according to the invention, which comprises a passive location-based contact search on a mobile device, whereby location data is collected according to the method described previously, and may be compared to a user's contacts stored in a mobile device. An RASS may then filter out any contacts who are not participants in the system of the invention, and then apply location data gathered as well as a user-selectable radius, to determine whether a contact is within such a radius' proximity to the user. This could then enable a user to make more informed decision regarding a contact's socially-available status, such as choosing to send them a text message or phone call, or adding them to a social event or group as described below. Such a feature should also take into consideration whether contacts have chosen to “opt-out” of sharing their location-based data with this feature, according to each user's personal privacy settings.

An additional feature may be implemented by an RASS according to the invention that, upon assessing a concentration of a particular type of people in a particular area, will “ping” or alert a selection of targeted users in that area to ask what type of activity they are involved in to determine if that event or activity should be added to the database and be recommended to other users that might enjoy it or simply show up in general searches. Such a request might be customizable, or individual users might be allowed to “opt out” of receiving such alerts in a preferences settings, allowing each user to participate in the RASS in the manner and degree of their preference. It will be appreciated that such features mentioned are exemplary, and additional or alternate procedures or technologies might be implemented according to the invention.

An RSCE may be an active feedback loop (whereas the RASS feature described above was entirely passive) whereby a user, via a simple “tag-based” interface, can provide more current information and feedback on locations, establishments, events or activities than what is available via review or rating aggregation services such as Yelp or other similar review and rating systems.

It will be appreciated by one having ordinary skill in the art, that an apparent challenge with any such review system lies within incentivizing users to participate. According to the embodiment, incentivizing may be accomplished by first making the system extremely simple, easy, and fast using the described system of tags rather than an actual prose-based review, thus providing a convenient and user-friendly experience that requires minimum effort or time. Furthermore, there could be an opportunity to provide incentives to reviewers in terms of a reward point program that can be redeemed for discounts at participating local establishments, or similar rewards program as is common in the art. Such a program may be tailored by an establishment and could optionally be related to an advertising campaign, further encouraging both users and establishment owners to participate and utilize the system of the invention to improve their respective experience. A further feature with respect to establishment operators could comprise a system similar to existing Internet-based advertising based on “click-through”, in which an advertising service pays for advertising only when a user clicks on the relevant advertisement or link. According to the invention, such a feature may be implemented wherein an establishment operator is only required to pay for advertising that results in a paying customer attending an event or purchasing goods or services, rather than simply for placement in an ad spot or search results.

An SGC may be implemented to facilitate coordinating a group of 2 or more friends who wish to come together in a social context in an efficient manner. This may be accomplished by implementing an invitation system, targeted at coordinating and planning everyday social interactions, rather than focusing solely on special events like parties, however it will be appreciated that the nature of the invention may be readily adapted for use for a variety of events, including gatherings of a more formal nature. Invites may be sent out by the group organizer to known individuals, contact information for which might be entered manually or retrieved from a data store such as a mobile phone's address book. One of the options available to the organizer will be to make the group “open” or “private”. In the case of the former, any member who has joined a group would then be able to invite others to join as well, whereas in the latter case only the group organizer can add others to the crew. The group may also have a specific start and end time as specified by the organizer, or additional users with elevated privileges (such as alternate/additional leaders or moderators), such as the ability to modify an event's schedule or invite or reject other members, thereby making the challenge of leading and coordinating an event more convenient by allowing distribution of labor and management.

An individual who has joined a group might then have the opportunity to interact with other members of the group in a variety of ways:
Message board: each group might be provided with access to a group message board which functions in a manner similar to group text or bulletin board systems where messages sent are readable by all members. This feature could be available before, during, and after the specified duration of a group, if supplied.
Photo Sharing: the application will allow photos to be taken and shared among the members of the crew. Initially these will just be in the form of reduced file size images appropriate for mobile devices, but eventually may include access to a web based portal that allows the user to download the full sized photo images.
Location Broadcast: for a specific duration that a group is specified as active, all members of the crew could have the ability to see the location of other crew members (optionally updated at periodic intervals, which could be customizable by either an individual group member or set initially by a group organizer). A group organizer could be highlighted, as could a current “group location” which may be a specific venue designated as the meeting place or social venue of choice. Alerts may also be set for specific members of a group so that a user will be notified when they arrive at a chosen venue.
Venue Updates: a group organizer or leader, or other group members with elevated privileges as described above, may have the ability to update the group with a new chosen venue or event as its destination or current location. This could then send notifications to group members notifying them of the change.

An RSG may be implemented to help users connect with other like-minded individuals in a social setting that meets their particular set of shared interests. In some cases this could be as simple as a bar with the features and crowd that they prefer, or it could be as elaborate as a paid event like a concert or professional sporting event. It will be appreciated that such a feature may be readily adapted to a wide variety of settings, and that those mentioned are exemplary. According to the embodiment, a user may be prompted to specify a date and time that they are available to attend a group, along with some specifications about the type of event they are interested in (food, alcohol, sports, etc.). An RSG system could then attempt to match them with a suitable group of other individuals based on the selected preferences and options. In this manner, the RSG may be considered to be an autonomous search engine that presents findings to a user for approval, allowing users to connect without proactively seeking each other out, allowing users to find and connect with individuals without knowing any details about them.

In another preferred embodiment of the invention, a mobile application utilizing the method of the invention and suitable for use on a mobile computing device such as a smartphone or tablet computer, is disclosed. It will be appreciated that a method for tag-based social networking as described previously may be readily adapted to a variety of software or hardware implementations such as (but not limited to) mobile phones, smartphones, personal digital assistants, tablet computers, or other personal computing devices. It will be appreciated by one having skill in the art, that a variety of devices exist and are being developed in the art, which utilize location awareness or other features to provide “augmented reality” functions to a user, and that such devices may also be utilized according to the invention. It will be further appreciated that such a method does not rely on any specific implementation and those described are exemplary, and may vary according to the invention.

According to the embodiment, a mobile application may allow a user to create a personal identity or profile using tags as personal identifiers, as described above. A user may update such a profile as needed, adding or removing tags to refine their description as it may be presented to other users. A user may optionally be allowed to customize other aspects of the application, such as setting preferences for update intervals or notifications (a user might select not to receive notifications when the app is not running in the foreground, for example). In this manner, a single software implementation of the method of the invention may accommodate a broad user base by allowing users to tailor the behavior and experience to their personal tastes, rather than feeling “shoehorned” into a “one size fits all” application.

According to the embodiment, an RASS may be implemented either within the mobile application or running remotely on a server, sending updates to the application via a data network. A user may view the results of RASS operation from within the application, such as viewing a map display showing the immediate surrounding area with other users highlighted or with optional overlays displaying additional information such as locations of groups, density map or “heat map” style overlay displaying aggregated information on user location (as an example, if multiple users tagged with “dog lover” are located in a park when an RASS updates their location information, this might be presented as a shaded or colored area around the park). Such displays may be customizable by the user, such as selecting tags to refine the display of users or groups, or organizing the display such as using color-coded markers or symbols to represent tags for quick viewing. A user might then be allowed to store customizations for future use, or could choose to discard the changes, leaving previously-stored customizations in place (if any).

An SGC may be implemented by a mobile application as an interface for group creation or interaction, again including the option to use tag-based data along with manually-inputted text as appropriate. While tag-based characteristic identifiers may be used interchangeably with actual typed text input, the inventor has determined that it may be desirable or in fact optimal to fully eliminate the need for text-based input where possible, opting for a “keyboard free” approach to input using only tag-based identifiers whenever possible. Such an interface may allow a user to create a new group and set descriptive tags, as well as invite other users to join. When an invitation is sent, it may trigger a popup or other alert on an invited user's application, notifying them of the request and optionally giving them a means to join a group easily (such as an alert window with an “accept invite” button). If an invited individual is not using the application, an SGC might send a text message to their mobile phone, or an e-mail notifying them of the invitation (if the respective contact information is available). It will be appreciated that such communication methods are exemplary and many alternate means may be utilized according to the invention. When users join a group, they may use an SGC interface to view group info, view details on other individuals within the group, leave a group, or if they have permission (either default or optionally as granted by the group's creator), edit group properties or details such as location or description tags.

An RSG may be implemented according to the embodiment as an interface allowing a user to set preferences such as locations where they would like to participate in events, date and time they are available, or event-specific details such as willingness to pay for a ticket. Such data is exemplary, and it will be appreciated that a wide variety of information may be applicable according to the invention. An RSG may then use this information to determine whether a user should be made available to event or group coordinators, thereby allowing a user to make themselves available and passively connect with others (i.e., connect without knowing any information about other individuals or become a potential candidate for a group before such a group is even created).

According to a preferred embodiment of the invention, a system for social networking and interaction is disclosed, comprising: a real-time anonymous social search engine stored and operating on a network-attached server computer; a real-time social curation engine stored and operating on a network-attached server computer; a social group coordination engine stored and operating on a network-attached server computer; and a real-time social grouping engine stored and operating on a network-attached server computer. According to the preferred embodiment, the real-time anonymous social search engine enables users to create and maintain personal profiles, and carries out a process comprising the steps of: locating a first user; determining if the user is socially available; and aggregating tag-based information; the real-time social curation engine receives tag-based reviews of locations from users and rewards users based on a specific configuration; the social group coordination engine carries out the steps of: aggregating information received from the real-time anonymous search engine and the real-time social curation engine; allows users to create or edit social groups; allows users to interact with groups; and allows users to review the location of groups to which they belong; and the real-time social grouping engine searches known user information to recommend connections between a plurality of specific users and potentially facilitate an in-person group meeting between them.

According to another preferred embodiment of the invention, a method for tag-based social interaction, comprising the steps of: (a) creating, using a real-time social search engine stored and operating on a network-connected server computer, a plurality of user profiles using tag-based characteristic identifiers, the plurality of user profiles pertaining to a plurality of users; (b) updating a first user's location-based data; (c) determining whether the first user is in a socially-available context; and (d) aggregating tag-based information of a plurality of socially-available users for viewing, is disclosed. In a further embodiment, the method comprises the additional steps of: (e) creating, using a social group coordination engine stored and operating on a network-connected server computer, a group of users using aggregated tag-based information to select members; (f) choosing a group location based on aggregated tag-based information available for establishments; and (g) enabling the group of users to interact with each other. In yet another embodiment, the method further comprises the additional steps of: (h) receiving tag-based reviews of establishments from a plurality of reviewing users; and (i) rewarding one or more of the plurality of reviewing users for submission of review information. In another embodiment of the invention, the method is further characterized in that tag-based review information is used to refine search and presentation of information pertaining to a specific establishment.

It is the intention of the inventor that in an ideal arrangement as described in the preferred embodiments, a mobile application will be fully-functional for the intended purposes while rarely, if ever, requiring the use of a keyboard (either physical or virtual such as on-screen input common in smartphones), and all user interaction may be accomplished through tag-based identifiers present within an application according to the embodiment. It will be appreciated that alternate configurations may be utilized and that other inputs such as traditional text-based typed input may be desirable according to a particular arrangement of features and such an embodiment is exemplary, however the inventor considers this to be the ideal implementation according to the intent of the invention.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is a block diagram illustrating an exemplary system architecture according to an embodiment of the invention.

FIG. 5 is a flow diagram illustrating a method for providing tag-based social interaction, according to a preferred embodiment of the invention.

FIG. 6 is an illustration of an exemplary user interface for a mobile application, illustrating tag-based input of personal information according to an embodiment of the invention.

### DETAILED DESCRIPTION

The inventor has conceived, and reduced to practice, a method for tag-based social interaction and connectivity, and a mobile software application for utilization of such a method.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A “tag”, as used herein, is a brief characteristic descriptor that may be applied to an individual, group, or organization for purposes of identifying or scoring various attributes. Tags may be implemented as clickable or otherwise interactive buttons or text elements within software embodiments, and optionally may be applied multiple times (if appropriate according to the nature of the implementation) to achieve a weighted score for an attribute.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

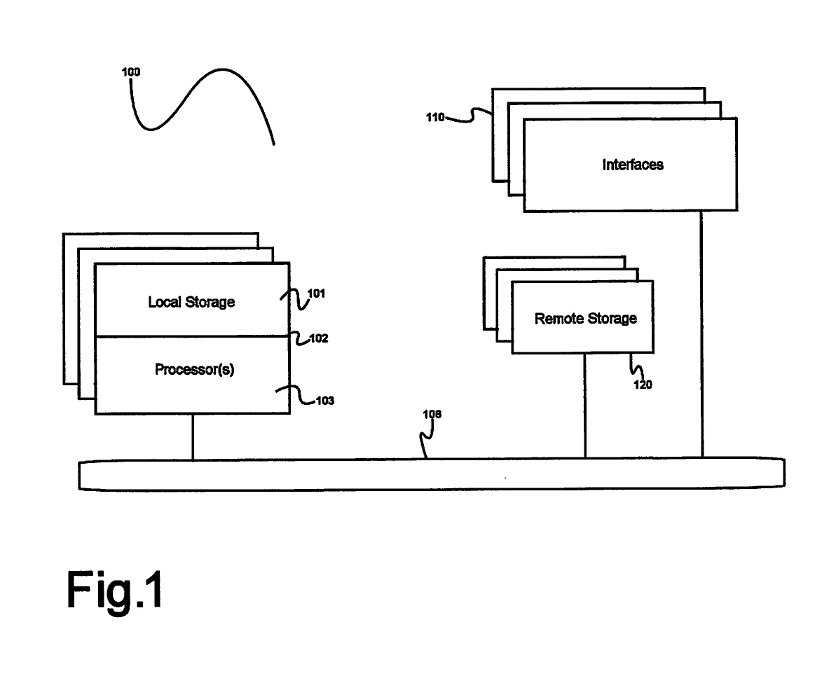

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110.

In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

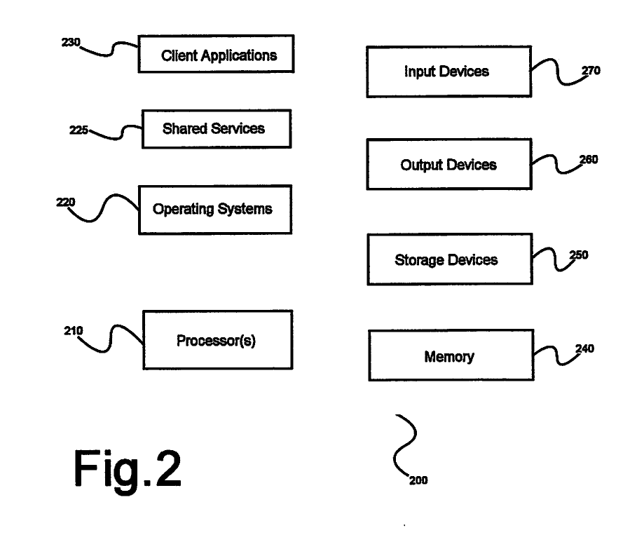

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

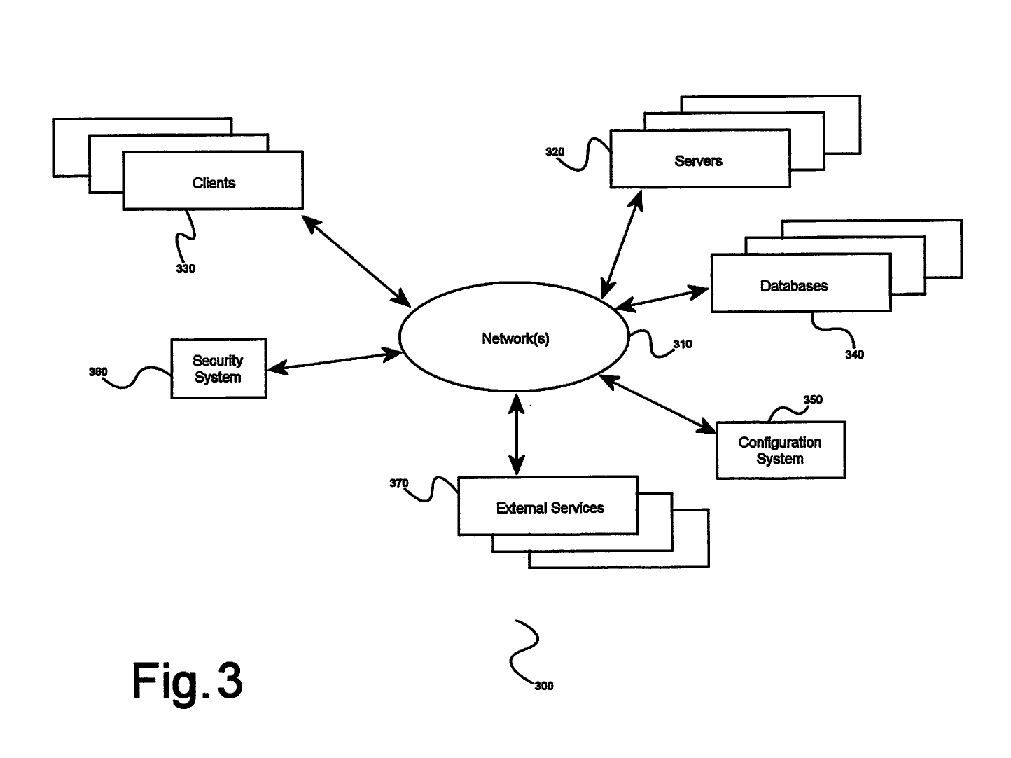

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

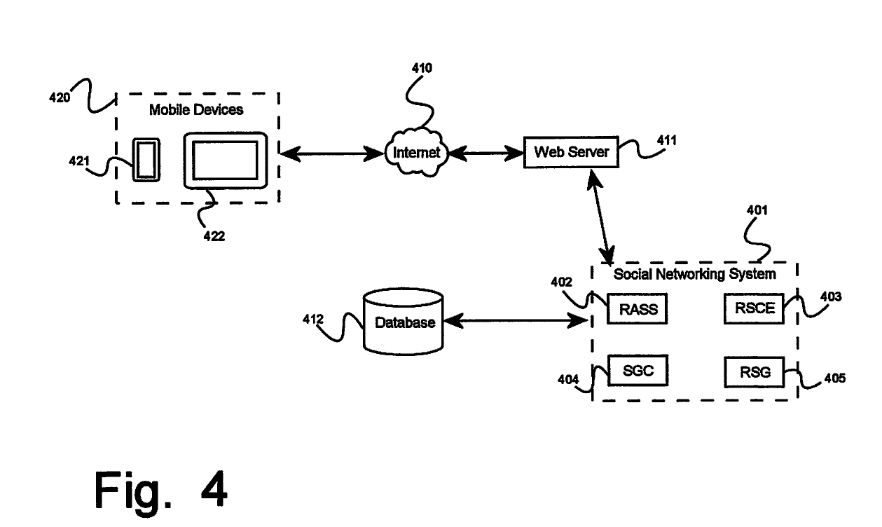

FIG. 4 is a block diagram illustrating an exemplary system architecture for providing a method of tag-based social networking, according to an embodiment of the invention. As illustrated, a social networking system 401 may comprise the various elements described previously, such as a real-time anonymous social search (RASS) engine 402, a real-time social curation (RSCE) engine 403, a social group coordination (SGC) engine 404, and a real-time social grouping (RSG) engine 405. Such elements may exist optionally as physical or hardware elements (such as a computer server dedicated to performing the tasks of a RASS engine), or they may be virtual or software elements hosted on hardware (such as might enable multiple software elements to utilize a single, shared hardware). It will be appreciated that such elements may be physically grouped as illustrated, such as internal components of a server network developed to provide tag-based social networking functionality, or they may be separate, hosted elements which communicate via an internet 410 or other data network. In this manner, it should be appreciated that the physical arrangement and location of such elements is exemplary, and any of a variety of configurations may be possible according to the invention.

As illustrated, a social networking system 401 may interface with a web server 411 for presenting online or web-enabled content to user via an Internet or other data network 410. Users may connect via any of a number of web-enabled mobile devices 420, such as (as illustrated) a mobile smartphone 421 or tablet computing device 422. It should be appreciated that such web-enabled content may take many forms, and could comprise other data for use with alternate devices according to the invention, such as (for example) implementing a webpage-based interface for viewing and interaction with any of a number of traditional personal computer devices such as a laptop or desktop computer. It will be further appreciated that as the art continues to develop, new forms of content or new devices may become available and be utilized according to the invention.

As further illustrated, a social networking system 401 may utilize a database or similar storage medium 412, for the storage and retrieval of information such as personal profiles comprising tags as described previously. It will be appreciated by one having ordinary skill in the art, that such a storage medium may be of varied construction and implementation such as a database collocated with physical components of a social networking system 401 with which it may interface, a physical datastore such as a database or disk storage system located remotely from physical components of social networking system 401, or a remote or cloud-hosted storage service as is common in the art and accessible via an internet or other data network 410. It will be appreciated that the arrangement shown is exemplary and for illustrative purposes, and that alternate arrangements may be possible according to the invention.

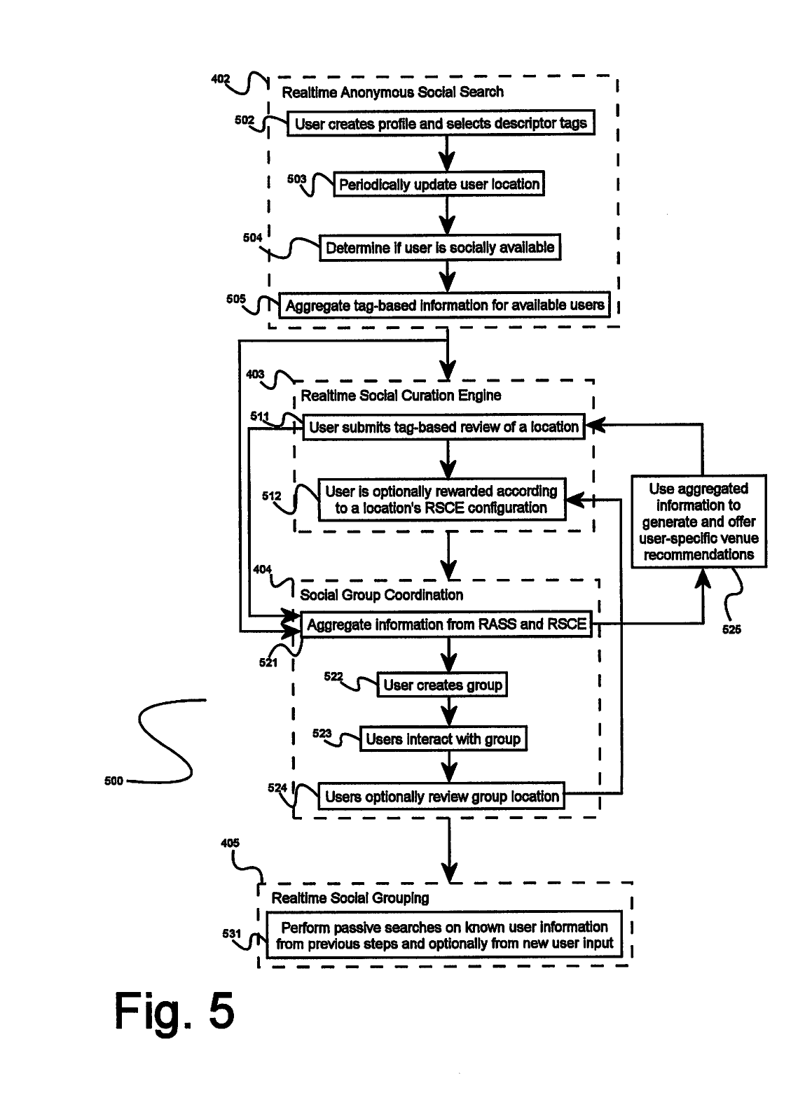

FIG. 5 is a block diagram illustrating a method 500 for tag-based social interaction and review, according to a preferred embodiment of the invention. As illustrated, a RASS actor 402 (that is, a real-time anonymous social search (RASS) engine), carries out a plurality of steps of method 500 to facilitate tagging and searching of users. In step 502, a user may create a profile and select tags to identify them within a social context, such as demographic identifiers (such as age, gender, sexual preference, or other identifiers) or personal identifiers such as interests, hobbies, or other identification information. It will be appreciated that the nature of such information is highly variable, and that the identifiers given are exemplary in nature and a wide variety of information may be utilized according to the invention. In a next step 503, a user's location may be periodically updated within a system 401. Using this location information, in a step 504 a user may be determined to be in a socially-available context, i.e. at a social event or venue where social interaction is likely. According to such a determination, in a step 505 a user's tag-based identification information may be aggregated with other users for further use according to the invention, as described below.

As illustrated, a RSCE actor 403 (that is, a real-time social curation engine), may carry out further steps of method 500 of the invention. A user may submit tag-based reviews or ratings of locations according to a step 511. Such a location may be a user's present location or it may be a selected location from a list or map view, allowing a user to submit reviews on previously-visited venues as may be desirable (for example, after an event has concluded and a user has returned to the comfort of their home, or in the case of a business event perhaps after a user has left the corporate setting and has personal time in which to submit such a review). In a further step 512, a user may be optionally rewarded for their review input according to a location's configuration, such as participation in a member rewards program which might award redeemable points to individuals who review their establishment. Such a system would encourage users to submit reviews on their frequented establishments, as well as encourage establishment owners to participate in a program to expand their business through word-of-mouth and encourage repeat customers due to collected rewards.

A review or ratings system as described according to a RSCE 403 may be utilized to refine and optimize search results or recommendations for various features of invention. For example, if a user wishes to search for a specific type of venue for hosting an event, previous ratings from a plurality of users may be taken into consideration when sorting and displaying results of a search, or may optionally be directly viewable alongside a venue's information (such as displaying a venue's name and information, along with a selection of frequently-used tags from reviews). In this manner, results being presented to a user are constantly being refined to be more relevant and useful, and it will be appreciated that such a method of refinement may be applied to one or a variety of features according to the invention.

As illustrated, an SGC actor 404 (that is, a social group coordination engine), may collect data from previous actors 402 and 403, forming an aggregated information base of users and locations using anonymous, tag-based identifiers in step 521. In a looping step 525, aggregated information may be utilized to generate and provide a user with specific venue recommendations based upon known information collected from a variety of sources. In a step 522, a user may create a group for other users to participate in events or coordinate activities based upon their given tag-based information such as shared interests or demographic information (for example, a user might create a group for a tennis based event, choosing to filter and include users who selected tags describing an interest or skill level in tennis). In a further step 523, users may interact with a group such as joining a group, or if allowed to do so (as may be set by the group creator), modifying group qualities such as a destination location for an event or timing of an event as it might be rescheduled. Passive information updates may optionally be provided to group members according to a group configuration (which may be set or modified by a group coordinator or users with elevated privileges), such as notifications of changes in location, changes in member status, or real-time venue ratings. In a final step 523, users may submit reviews or ratings of a group's location, such as might be appropriate when an event is concluded and each user wants to review their experience. As illustrated, users who participate in reviews may be rewarded according to the nature of a location, such as if a rewards program is implemented (as described above). Group members may optionally access group information after the conclusion of an event, such as for exchanging contact information or sharing photographs or other files, or accessing a list of group members for use in future group coordination or other social interaction.

A RSG actor 405 (that is, a real-time social grouping engine), may collect information aggregated across previous actors 402, 403, and 404 and in step 531 utilize such information in generating passive searches to connect users with each other according to chosen tags, shared location information (such as individuals who frequent similar establishments or attend similar events), a user's feedback on particular venues via RSCE, or optionally from newly-submitted user information (such as a user manually choosing new tags to attempt to connect with more individuals and expand their social circle).

It will be appreciated by one having skill in the art, that such information and procedures as described above are exemplary in nature and alternate configuration or methods may be utilized according to the invention, and that a wide variety of information may be utilized in identifying users or locations and that such information may be updated or altered according to the invention, such as the addition of new tags for users to select or new options to be implemented when reviewing a location.

### Detailed Description of Exemplary Embodiments

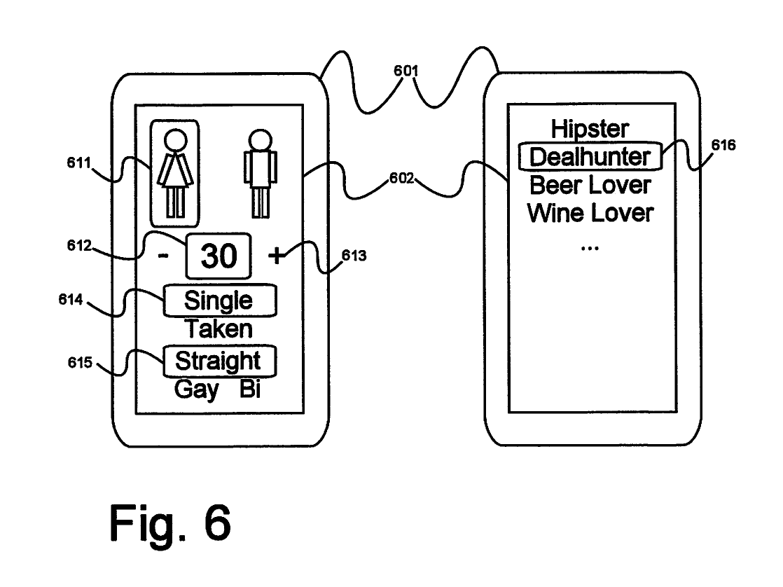

FIG. 6 is an illustration of an exemplary user interface for a mobile application 601, illustrating an interface 602 for creation of a user profile and selection of personal identifier tags. As illustrated, an interface 602 may utilize a variety of clickable or otherwise user-interactive elements, such as icons, buttons, selectable text elements, or increment/decrement controls 613 for numerical text fields, and it will be appreciated that such elements as illustrated are exemplary and a variety of elements may be utilized according to the invention. As illustrated, a user may select demographic information to identify them to other users, such as gender 611, age 612, relationship status 614, or sexual orientation 615. Such identifiers may allow for multiple selections, or may require only a single selection to be made (such as restricting a user to only select a single gender). As further illustrated, a user may also select a plurality of personal identifiers such as jobs, hobbies, or interests 616, to identify them to other users who may share such interests or otherwise desire to meet individuals with such tags (for example, a user may wish to learn more about wine and familiarize themselves with the wine culture, by seeking out users who have selected tags associated with an interest in wine such as “wine connoisseur” or “vintner”).

In some embodiments, mobile application 601 may display a view of a user's surrounding area on a map, optionally displaying the user's current location with an arrow or similar marker to show their position relative to the surroundings. Such a map may be a proprietary graphic or may be integrated with existing mapping services common in the art such as Google Maps or Yahoo Maps, and may be configurable by a user as to the source of mapping information so that a user may choose to view map information with which they are more familiar (for example, a user who is used to using Google Maps may select it as the default service to use whenever available). As further illustrated, additional information may be displayed as an “overlay” on a map image, optionally including other users, locations, or (as illustrated) “heat map”-style overlays illustrating the frequency with which users attend certain locations or areas. As illustrated, multiple areas may be shown simultaneously for the purpose of comparison, such as showing areas shaded, colored, outlined, or otherwise delineated according to the tags with which they are associated (such as showing dashed-outline areas representing the frequent locations of users with tag “A”, and dotted-outline areas representing users with tag “B”). In this manner, a user may view multiple social contexts at once and make a more informed decision about where to spend their time according to their own interests, optimizing the manner in which their time is spent for social interaction.

It will be appreciated by one having ordinary skill in the art, that such implementations of a mobile application as illustrated are exemplary in nature, and various components of a social networking interface may be implemented in a variety of ways according to the invention, such as tabs within a single application, multiple independent applications which may work together with a single social networking service running on a data network such as the internet, or any of a variety of other implementations as may be found in the art. It will be further appreciated that the implementation of mobile applications may vary according to the mobile device or environment in which they are implemented, and that implementations may vary as the art develops and new technologies or methods become available, any of which may be utilized according to the invention.

The skilled person will be aware of a range of possible modifications of the various embodiments described above. Accordingly, the present invention is defined by the claims and their equivalents.

1. A system for social networking and interaction, comprising:
a real-time anonymous social search engine stored and operating on a network-attached server computer;
a real-time social curation engine stored and operating on a network-attached server computer;
a social group coordination engine stored and operating on a network-attached server computer; and
a real-time social grouping engine stored and operating on a network-attached server computer;
wherein the real-time anonymous social search engine enables users to create and maintain personal profiles, and carries out a process comprising the steps of: locating a first user; determining if the user is socially available; and aggregating tag-based information;
further wherein the real-time social curation engine receives tag-based reviews of locations from users and rewards users based on a specific configuration;
further wherein the social group coordination engine carries out the steps of: aggregating information received from the real-time anonymous search engine and the real-time social curation engine; allows users to create or edit social groups; allows users to interact with groups; and allows users to review the location of groups to which they belong; and
wherein the real-time social grouping engine searches known user information to recommend connections between a plurality of specific users.

2. The system of claim 1, wherein tag-based characteristic identifiers are used by the real-time anonymous social search engine.

3. The system of claim 2, wherein the tag-based characteristic identifiers are applied to individual users in place of detailed personally-identifiable information.

4. The system of claim 2, wherein the tag-based characteristic identifiers are applied to groups of users.

5. The system of claim 2, wherein the tag-based characteristic identifiers are applied to establishments or venues.

6. The system of claim 2, wherein location-based data is collected from participating users.

7. The system of claim 6, wherein the location-based data is stored in a cloud-based storage medium.

8. The system of claim 7, wherein the location-based data is served to users on-demand when appropriate.

9. A method for tag-based social interaction, comprising the steps of:
(a) creating, using a real-time social search engine stored and operating on a network-connected server computer, a plurality of user profiles using tag-based characteristic identifiers, the plurality of user profiles pertaining to a plurality of users;
(b) updating a first user's location-based data;
(c) determining whether the first user is in a socially-available context; and
(d) aggregating tag-based information of a plurality of socially-available users for viewing.

10. The method of claim 9, further comprising the additional steps of:
(e) creating, using a social group coordination engine stored and operating on a network-connected server computer, a group of users using aggregated tag-based information to select members;
(f) choosing a group location based on aggregated tag-based information available for establishments; and
(g) enabling the group of users to interact with each other.

11. The method of claim 10, further comprising the additional steps of:
(h) receiving tag-based reviews of establishments from a plurality of reviewing users; and
(i) rewarding one or more of the plurality of reviewing users for submission of review information.

12. The method of claim 11, wherein tag-based review information is used to refine search and presentation of information pertaining to a specific establishment.

13. The method of claim 9, wherein location and tag-based data is used to refine search and presentation of other users.

14. The method of claim 9, wherein location and tag-based data is used to passively analyze a user's mobile device contacts.
